(19) United States
(12) Patent Application Publication
(10) Pub. No.: US 2024/0215749 A1
(43) Pub. Date: Jul. 4, 2024

(54) DEVICE FOR COOKING FOOD

(71) Applicant: GMS - Geraete, Maschinen, Systeme - Handelsgesellschaft mbH, Krefeld (DE)

(72) Inventor: Gerhard HOENEN, Krefeld (DE)

(73) Assignee: GMS - Geraete, Maschinen, Systeme - Handelsgesellschaft mbH, Krefeld (DE)

(21) Appl. No.: 18/605,561

(22) Filed: Mar. 14, 2024

Related U.S. Application Data
(63) Continuation of application No. PCT/DE2022/100665, filed on Sep. 8, 2022.

(30) Foreign Application Priority Data
Sep. 14, 2021 (DE) 10 2021 123 790.4

(51) Int. Cl. A47J 29/02

(52) U.S. Cl. CPC A47J 29/02

(57) ABSTRACT

A device for cooking food, the device includes an elongate outer tube which can be sealed at its lower end and an elongate inner tube, the outer diameter of which is smaller than the inner diameter of the outer tube such that the inner tube can be inserted longitudinally into the outer tube thereby forming an annular gap between the inner tube and the outer tube. A closing piece can be placed on an open upper end of the outer tube and can be fastened thereto. At least one passage opening is formed in an end face of the closing piece, which passage opening is aligned with the annular gap, in such a way that the annular gap can be filled from the outside through the passage opening when the closing piece is placed on the upper end of the outer tube.

This nonprovisional application is a continuation of International Application No. PCT/DE2022/100665, which was filed on Sep. 8, 2022, and which claims priority to German Patent Application No. 10 2021 123 790.4, which was filed in Germany on Sep. 14, 2021, and which are both herein incorporated by reference.

### BACKGROUND OF THE INVENTION

### Field of the Invention

The invention relates to a device for cooking a food, in particular a mass to be cooked, which contains egg and/or egg fractions or is formed from these ingredients.

### Description of the Background Art

According to the state of the art, it is known to prepare a fermentable mass containing egg and/or egg fractions or formed from these ingredients by cooking them in a cylindrical device, wherein this device consists of an outer tube and an inner tube to be inserted therein. For example, such a device is used for the production of so-called “long egg”. Particularly in the event that such a device is not used industrially and is instead used manually by private individuals, the use of such a device is problematic in practice in that the inner tube, when inserted inside the outer tube, remains precisely and centrically positioned within the outer tube. Furthermore, another problem with this type of device is that the ring gap that forms between the outer tube and the inner tube inserted in it can be easily filled with the mass to be cooked.

DE 21 34 741 A shows a device for cooking a food and is used for the industrial production of an unpackaged egg product consisting of a cylindrical core of coagulated egg yolk and coagulated egg white surrounding it. Accordingly, the individual components of this device are mechanically controlled or moved during operation.

### SUMMARY OF THE INVENTION

It is therefore an object of the invention to overcome the problems associated with the conventional art for a device for cooking a food.

A device according to an example of the invention is used for cooking a food, in particular a mass to be cooked, which contains egg and/or egg fractions or is formed from these ingredients. For example, this device can be used for the preparation of the so-called “long egg”, which can be illustrates as a log of boiled egg that is cylindrical in shape. In any case, the device according to the invention comprises an elongated outer tube which can be closed at its bottom end and an elongated inner tube, the outer diameter of which is smaller than the inner diameter of the outer tube, so that the inner tube can be inserted lengthwise into the outer tube, leaving a ring gap between the inner tube and the outer tube. In addition, the device includes an end piece which can be placed on and attached to an open top end of the outer tube.

The device according to the invention is characterized by the fact that in or on the front of the end piece, at least one passage opening can be formed which is aligned with the ring gap formed between the inner tube and the outer tube, in such a way that, when the end piece is placed on the top end of the outer tube, the ring gap can be filled from the outside through at least one passage opening. The end piece is cup-shaped and thus open on its top side, with vertical partition walls provided in an inner area of the end piece. In the front of the end piece there are a number of passage openings which are aligned with the ring gap formed between the inner tube and the outer tube, with at least one passage opening being fluidically demarcated from the other passage openings by the partition walls, so that this passage opening fulfils the function of a ventilation opening when the ring gap is filled with a mass to be cooked through the other passage openings.

When the end piece is placed on the top end of the outer tube, the inner tube can be held centrically within the outer tube by the end piece.

With the aid of the device according to the invention, it is ensured that the handling or exact positioning of the inner tube relative to the outer tube, i.e., centrically within the outer tube, is considerably simplified by means of the end piece. The purpose of the end piece is for the ring gap, formed as intended between the outer tube and the inner tube inserted therein, as long as the inner tube is inserted within the outer tube, to assume or retain a uniform dimension even in the practical use of the device, and in the same way to ensure that this ring gap can be easily filled from the outside with the food or mass to be cooked through the at least one passage opening of the end piece.

The end piece may have a centric guide opening at its front, the inner diameter of which is adapted to an outer diameter of the inner tube, wherein the inner tube has a greater length than the outer tube, and the inner tube, when inserted in the outer tube, protrudes from the outer tube upwards and is surrounded by the centric guide opening. By holding the inner tube by means of the centric guide opening, an exact positioning of the inner tube centrically within the outer tube is achieved with mechanically simple and inexpensive means.

The inner tube, if it is held centrically within the outer tube, can be removed upwards from the outer tube by the centric guide opening of the end piece. This ensures that, for the device according to the invention, the inner tube can also be easily removed from the outer tube and is therefore only included in or remains inside the outer tube for as long as is necessary or desired to cook the food.

Due to the fact that a plurality of passage openings are formed in the front of the end piece, which are aligned with the ring gap formed between the inner tube and the outer tube, and that hereby at least one of these openings is fluidically separated by partition walls from the other passage openings so that this passage opening fulfils the function of a ventilation opening when the ring gap is filled with a mass to be cooked through the other passage openings, a fluidical demarcation of at least one passage opening from the other passage openings is achieved. This leads to the advantage that the ring gap can be filled with the food or mass to be cooked homogeneously from the outside, in particular without air pockets, because the air in the ring gap, which is displaced when the ring gap is filled with the food or mass to be cooked, can then escape out of the ring gap to the outside or upwards through the opening.

At least one receiving opening can be formed in one front of the end piece, in which a thermocouple or a float can be inserted. This makes it possible to insert a thermocouple, for example in the form of a rod-shaped thermometer, into the ring gap formed between the inner tube and the outer tube in order to measure the temperature of the mass to be cooked that is inside the ring gap. In the same way, a float, suitably in the form of a rod and made of temperature-resistant plastic, can also be inserted into the receiving opening in order to be able to obtain information, with the aid of the float, with respect to the fill level of the mass to be cooked within the ring gap.

A thermocouple with a particular rod-shaped design can at the same time perform the function of a float. In other words, in this case, a rod-shaped thermocouple or thermometer is integrated as a float at the same time. As a result, when using such a thermocouple in the receiving opening and operating the device according to the invention, it is possible to simultaneously obtain information regarding temperature and fill level of a mass to be cooked, which is filled into the ring gap formed between the inner tube and the outer tube.

On the bottom of the end piece, bayonet pins can be formed, which can be engaged with bayonet recesses formed adjacent to an top edge area of the outer tube in order to connect the end piece and the outer tube with each other. In other words, by means of these bayonet pins and corresponding recesses in the outer tube at its top end, it is possible both to reliably connect the outer tube and the end piece to each other by means of a positive fit and to be able to separate them from each other in the same way, preferably for cleaning purposes after using the device according to the invention.

A ring element may be attached to a bottom end of the outer tube, the inner diameter of which is adapted to the outer diameter of the outer tube. If an edge area at the bottom end of the outer tube is flanged, this ring element, when applied to the outer tube from the top end, can be supported on the flanged edge area of the outer tube with a bevel formed on its inner circumferential surface.

A purpose of the ring element mentioned above is to be able to attach an end cap to the open bottom end of the outer tube. For this purpose, an outer thread is formed on an outer circumferential surface of the ring element. Complementary to this, an inner thread is formed on an inner circumferential surface of the end cap, which is designed in the shape of a cup. This makes it possible for the end cap to be screwed onto the ring element, which is supported on the flanged edge area of the bottom end of the outer tube in order to close the open bottom end of the outer tube by means of the end cap.

Thanks to the use of the ring element, which, as explained, can be attached to the flanged edge area of the outer tube at its bottom end, it is possible that no further measures need to be taken on the outer tube, such as the formation of an outer thread or of the like, in order to attach the end cap to or on the bottom end of the outer tube. In this way, an inexpensive and robust manufacturability for the outer tube is guaranteed.

Between the end cap and the bottom end of the end tube, if the ring element is applied to the latter, a disc-shaped sealing element can be inserted. In keeping with its name, this sealing element makes it possible to improve the sealing effect between the end cap and the edge area at the bottom end of the outer tube.

A ring-shaped elevation may be formed in a central area of the sealing element on a side facing the inner tube, the diameter of which is adapted to the inner diameter of the inner tube, so that the inner tube, when it is inserted in the outer tube, rests on the elevation with its bottom open edge and is therefore kept centric within the outer tube.

Suitably, this ring-shaped elevation is conical at its outer circumference, so that the outer diameter of this ring-shaped elevation, starting from the surface of the sealing element, decreases upwards. Thus, it is possible that the inner tube, when it rests on the elevation, automatically centers itself with its bottom end or edge in relation to this elevation as a result of the weight force. This achieves a centric positioning of the inner tube within the outer tube.

A plurality of nubs may be formed on an underside of the end cap, which protrude from the underside. Conveniently, these nubs are arranged on the underside of the end cap adjacent to its outer circumference at uniform distances from each other. In any event, the purpose of these nubs is to ensure that the underside of the end cap, if it is attached to or on the bottom end of the outer tube as explained above, does not come into contact with the substrate when the device is placed on a surface, but instead is at a distance from the substrate corresponding to the height of the above-mentioned nubs. This is advantageous in the event that the device is placed in a water bath for heating or cooking purposes, so that the steam bubbles that form during heat can escape to the side in the area of the underside of the end cap. This then has an advantageous effect on the stability of the device within such a water bath.

A receptacle may be formed on the end piece in which a hanging bracket can be attached, with which the device can be hung when assembled. It is possible, for example, for the device to be hung in an oven when assembled by means of the above-mentioned hanging bracket, so that the mass to be cooked, which has been filled into the ring gap formed between the inner tube and the outer tube or into the outer tube, can be prepared in the heat of the oven.

As explained above, the device according to the invention is used in particular for the preparation of a so-called “long egg”. In this case, the device can be placed in a water bath (with hot water), as explained above, or hung up in a heated oven or convection oven with the aid of the hanging bracket. However, it is also possible to prepare other foods with the help of the inventive device, such as pancakes in the shape of sticks or the like. In any case, the ring gap between the outer tube and the inner tube inserted within it, and the ability to pull the inner tube out of the outer tube as soon as a food mass in the ring gap has been sufficiently cooked, with the core area within the outer tube thus being freed up, make it possible to prepare many tasty variants of a stick-shaped meal “on demand”, i.e., according to the user's choice.

The device according to the invention is suitable for the individual production of foods, in particular in the form of eggs in a roll or “long eggs”, in the context of home kitchen equipment or in commercial kitchens in gastronomy.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a side view of an inventive device in the assembled state

FIG. 2 shows a cross-sectional view of the inventive device along the line A-A of FIG. 1,

FIGS. 3(a) to 3(c) shows perspective views of the device of FIG. 1 from different directions,

FIG. 4 shows a side view of an outer tube, which is part of the device of FIG. 1,

FIG. 5 shows a sectional view of the outer tube along the line A-A of FIG. 4,

FIG. 6 shows a perspective view of the outer tube of FIG. 4,

FIG. 7 shows a side view of an inner tube, which is part of the device of FIG. 1,

FIG. 8 shows a perspective view of the inner tube of FIG. 7,

FIG. 9 shows a perspective view of an end piece from the top, this end piece being part of the device of FIG. 1,

FIG. 10 shows a perspective view of the end piece of FIG. 9 from the bottom,

FIG. 11 shows a front view of the end piece of FIG. 9 from the top,

FIG. 12 shows a top view of the end piece of FIG. 9,

FIG. 13 shows a sectional view of the end piece along the line H-H of FIG. 12,

FIG. 14 shows a sectional view of the end piece along the line A-A of FIG. 12,

FIG. 15 shows a perspective view of a ring element, which is part of the device of FIG. 1,

FIG. 16 shows a side view of the ring element of FIG. 15,

FIG. 17 shows a top view of an end cap from below, i.e., viewed from the bottom,

FIG. 18 shows a perspective view of the end cap of FIG. 17,

FIG. 19 shows a sectional view of the end cap along the line A-A of FIG. 17,

FIG. 20 shows a side view of a disc-shaped sealing element, which is part of the device of FIG. 1,

FIG. 21 shows a perspective view of the sealing element of FIG. 20,

FIG. 22 shows a perspective view of an inventive device according to an example,

FIG. 23 shows a perspective view of a hanging bracket, which is part of the device of FIG. 22, and

FIG. 24 shows a side view of the inventive device of FIG. 22.

### DETAILED DESCRIPTION

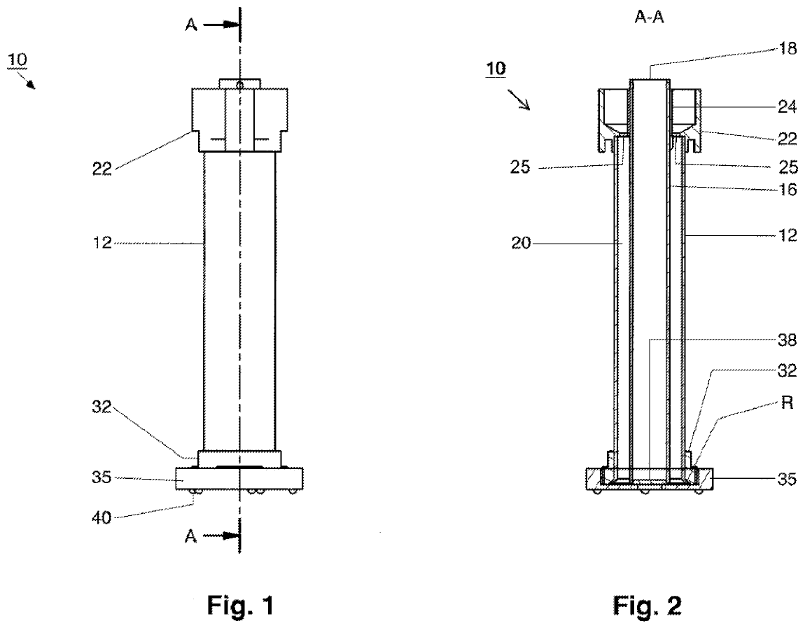

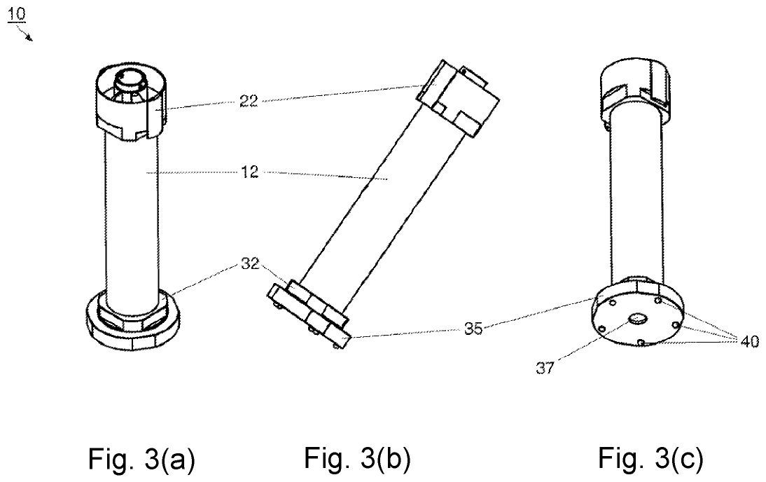

Below, with reference to FIGS. 1-24, preferred embodiments of a device according to the invention, with which a food can be cooked, are shown and explained. Such a food may be a mass to be cooked, which contains egg and/or egg fractions or is formed from these ingredients. At this point, it is pointed out separately that the drawing is only a simplification and is shown in particular without scale.

The device 10 according to the invention is shown in FIG. 1 in a side view, wherein FIG. 2 shows a sectional view along the line A-A of FIG. 1. The device 10 comprises an elongated outer tube 12 and also an elongated inner tube 16 (see FIG. 2). In view of the fact that the outer diameter of the inner tube 16 is smaller than the inner diameter of the outer tube 12, it is possible to insert the inner tube 16 lengthwise into the outer tube 12, as shown in FIG. 2.

If the inner tube 16 is inserted into the outer tube 12, a ring gap 20 is formed between these two tubes 12, 16 (see FIG. 2).

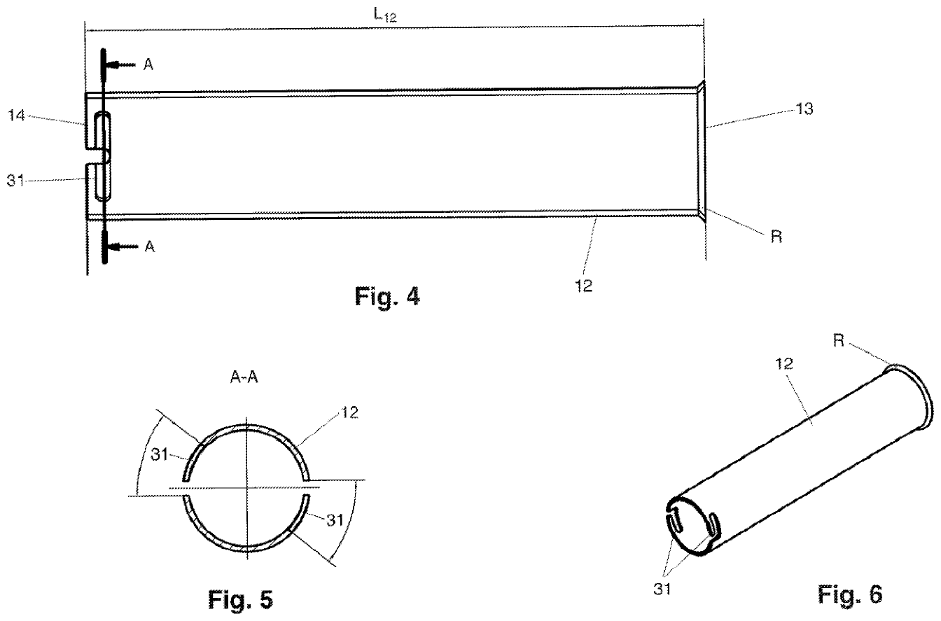

FIG. 4 shows the outer tube in a side view. This shows that the outer tube 12 has a bottom end 13 and an opposite top end 14. Adjacent to the top end 14 there are 12 bayonet recesses 31 in the wall of the outer tube, which are also shown in the sectional view of FIG. 5.

FIG. 6 shows the outer tube 12 in a perspective view. This shows that a flanged edge area R is formed at the bottom end 13 of the outer tube 12.

As already explained, the outer tube 12 is elongated and thus has a length which is indicated in FIG. 4 as “L₁₂”.

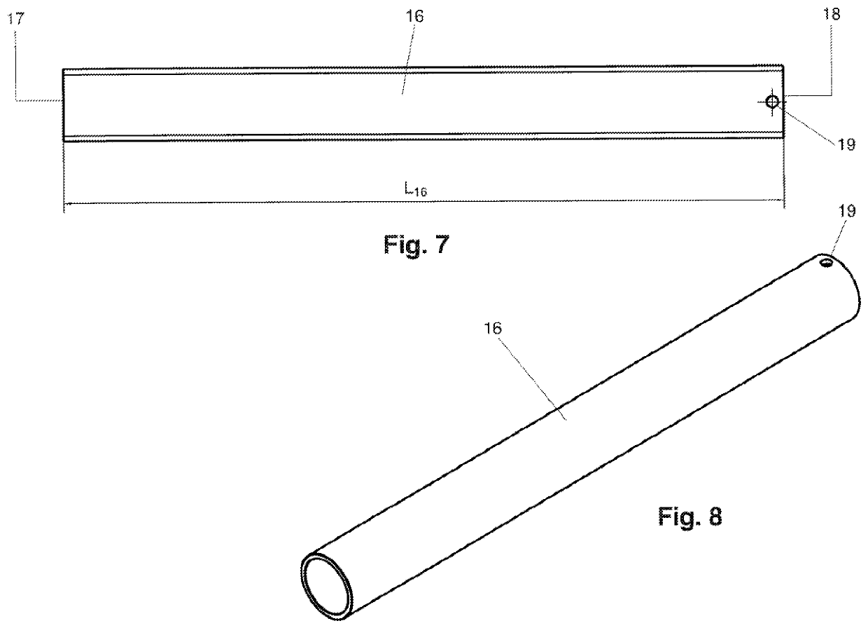

FIG. 7 shows the inner tube 16 in a side view. This shows that the inner tube 16 has a bottom end 17 and a top end 18. FIG. 8 shows the inner tube of FIG. 16 again and for better understanding in a perspective view.

Adjacent to the top end 18, 16 boreholes 19 are formed in the wall of the inner tube. The function of these boreholes 19 will be explained separately below.

As already explained, the inner tube 16 is elongated. The corresponding length of the inner tube 16 is indicated in FIG. 7 as “L₁₆”.

The device 10 also includes an end piece 22 (see FIG. 1).

With the aid of bayonet pins 30 (cf. FIG. 10, FIG. 14), which are attached to the bottom of the end piece 22, the end piece 22 can be form-fittingly attached to the bayonet recesses 31, which are formed at the top end 14 of the outer tube 12.

In the intended use of the device 10, the end piece 22 is attached to the top end 14 of the outer tube 12.

Following the use of the device 10, the end piece 22 can be unlocked and then removed from the top end 14 of the outer tube 12 thanks to the above-mentioned bayonet construction. This is particularly advantageous for cleaning purposes.

A comparison of FIG. 4 with FIG. 7 shows that the inner tube 16 has a greater length than the outer tube 12. This corresponds to the relationship:

$${L}_{16} > {L}_{12} .$$

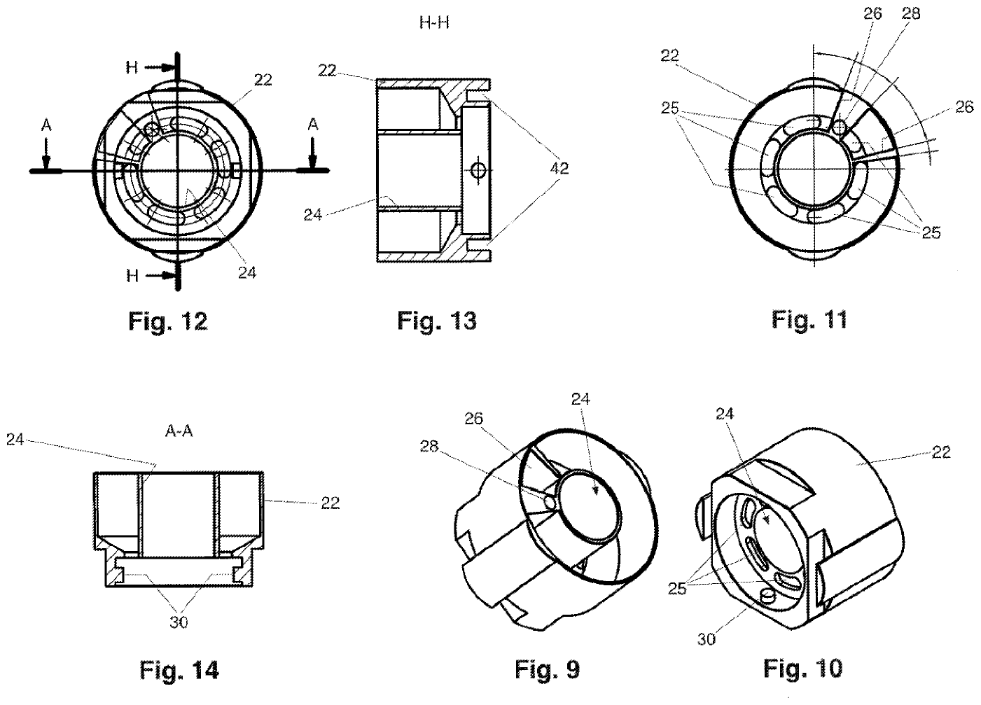

Below, with reference to FIGS. 9-14, further features of the end piece 22 are shown and explained as follows:

The end piece 22 has a centric guide opening 24 on its top front side.

Adjacent to this guide opening 24, a plurality of passage openings 25 (cf. FIG. 2, FIG. 10, FIG. 11) are formed in the end piece 22.

In the assembled state of the device 10, i.e., when the end piece 22 is connected to the top end 14 of the outer tube 12 by means of the above-mentioned bayonet construction, the inner tube 16 with its bottom end 17 can be inserted into the centric guide opening 24. In this way, it is possible to insert the inner tube 16 lengthwise into the outer tube 12.

In this case, the bottom end 17 of the inner tube 16 rests on an end cap 35, which can be attached to the bottom end 13 of the outer tube 12, as explained below.

In view of the fact that the length of the inner tube 16 is greater than that of the outer tube 12 (i.e., L₁₆>L₁₂), the inner tube 16, when inserted into the outer tube 12, protrudes with its top end 18 from the outer tube 12 and also from the centric guide opening 24. This is illustrated, for example, in FIG. 2.

When the end piece 22 is placed on the top end 14 of the outer tube 12, the passage openings 25, which are formed as explained in the end piece 22, align with the ring gap 20 formed between the outer tube 12 and the inner tube 16.

FIG. 11 illustrates that in an inner area of the end piece 22, vertical partition walls 26 are provided. Between these partition walls 26 there is at least one passage opening 25. The partition walls 26 have the function of fluidically demarcating the passage opening between them from the other passage openings 25, so that this passage opening 25 fulfils the function of a ventilation opening when the ring gap 20 is filled with a mass to be cooked through the other passage openings 25.

FIG. 11 further illustrates that in a front side of the end piece, a receiving opening 28 is formed. In the assembled state of the end piece 22 (cf. FIG. 2), this receiving opening 28 aligns with the ring gap 20. Accordingly, it is possible to insert a thermometer or a float, both of which are particularly rod-shaped, into the ring gap 20 through the receiving opening 28 in order to obtain information as to the temperature or fill level of a food or mass to be cooked which has been filled into the ring gap 20.

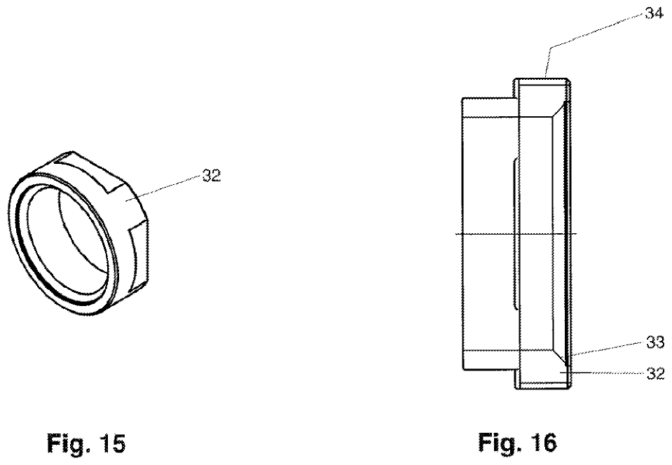

Below, it is explained with reference to FIGS. 15-21 how the bottom end 13 of the outer tube 12 can be closed by means of the end cap 35.

The device 10 according to the invention comprises a ring element 32, of which a perspective view is shown in FIG. 15. With regard to this ring element 32, it should be noted that its inner diameter is adapted to the outer diameter of the outer tube 12. Thus, it is possible to slide or thread the ring element 32 from the top end 14 onto the outer tube 12.

FIG. 16 illustrates that a bevel 33 is formed adjacent to a front side of the ring element 32, wherein adjacent hereto, on an outer circumferential surface of the ring element 32, an outer thread 34 is formed.

When the ring element 32 is pushed onto the outer tube 12, the ring element 32 slides towards the bottom end 13 of the outer tube 12 until its bevel 33 sits on the flanged edge area R on the bottom end 13 of the outer tube 12.

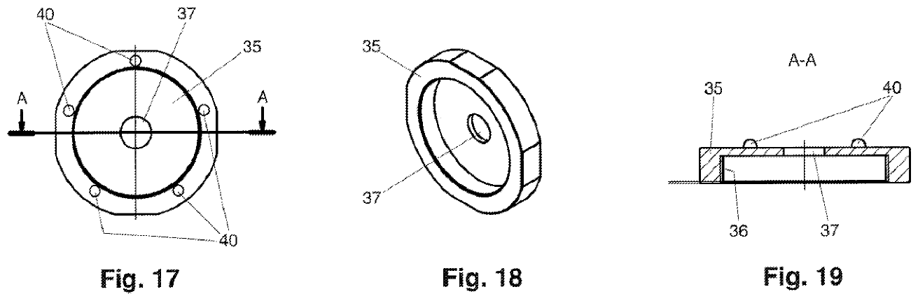

The end cap 35 mentioned above is shown in FIGS. 17-19.

FIG. 17 shows the end cap 35 in a view from below. This shows that a plurality of nubs 40 are formed on the underside of the end cap 35. FIG. 19, which shows a cross-sectional view of FIG. 17, illustrates that the nubs 40 each protrude from the underside of the end cap 35. The functionality of these nubs 40 is explained separately below.

The end cap 35 is designed in the shape of a cup, in accordance with the illustrations of FIG. 18 and FIG. 19. An inner thread 36 is formed on one of the inner circumferential surfaces of the end cap 35.

A centric area of the end cap 35 is traversed by a recess 37. This recess is indicated in FIGS. 17-19 by the reference sign “37”.

When assembling the inventive device 10, the first thing to be done, i.e., before placement of the end piece 22, is to thread the ring element 32 from the top end 14 onto the outer tube 20. As a result of this, the ring element 32 then slides to the bottom end 13 of the outer tube 12, wherein the bevel 33 of the ring element 32 rests on the flanged edge area R, which, as explained, is formed at the bottom end 13 of the outer tube 12. Then, the end cap 35 can be screwed onto the outer thread 34 of the ring element 32 with its inner thread 36.

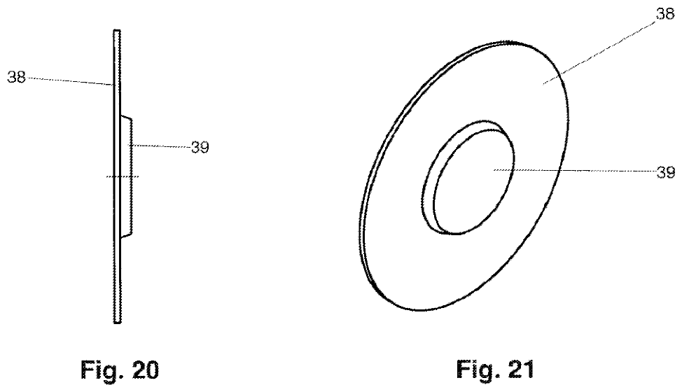

To improve the sealing effect between the open bottom end 13 of the outer tube 12 and the end cap 35 screwed to it, a disc-shaped sealing element 38 may be inserted between them, which is shown in FIG. 20 and FIG. 21, respectively, in a side view or perspective view.

Following screwing the end cap 35 to or with the bottom end 13 of the outer tube 12, the end piece 22 is then mounted on the top end 14 of the outer tube 12, wherein the inner tube 16 is inserted through the centric guide opening 24 and inserted in this way into the outer tube 12 (see FIG. 2).

The assembled state of the disc-shaped sealing element 38, i.e., when it is inserted between the bottom end 13 of the outer tube 12 and the end cap 35, is shown in FIG. 2.

In a central area of the sealing element 38, a ring-shaped elevation 39 is formed on a side facing the inner tube 16. In this case, the diameter of this elevation 39 is adapted to the inner diameter of the inner tube 16.

Conveniently, the ring-shaped elevation 39 is conical at its outer circumference. This can be seen in the perspective view of FIG. 21.

If the inner tube 16 is inserted into the outer tube 12 as explained (see FIG. 2), the inner tube 16 with its bottom end 17 sits on the ring-shaped elevation 39 as a result of its weight force, and possibly also by exerting a downward compressive force. In this case, the conical design of the elevation 39 engages in the inner edge of the inner tube 16 at its bottom end 17. The interaction between the conical elevation 39 and the bottom end 17 of the inner tube 16 results in that the inner tube 16 at its bottom end 17 is centered in the middle of the outer tube 12. The same applies to the top end 18 of the inner tube 16, where it is enclosed by the centric guide opening 24, as explained. As a result, the inner tube 16 is evenly centered within the outer tube 12 along its entire longitudinal extension. This results in a desired uniform value for the ring gap 20, which forms between the outer tube 12 and the inner tube 16, along a longitudinal extension of the two tubes 12, 16.

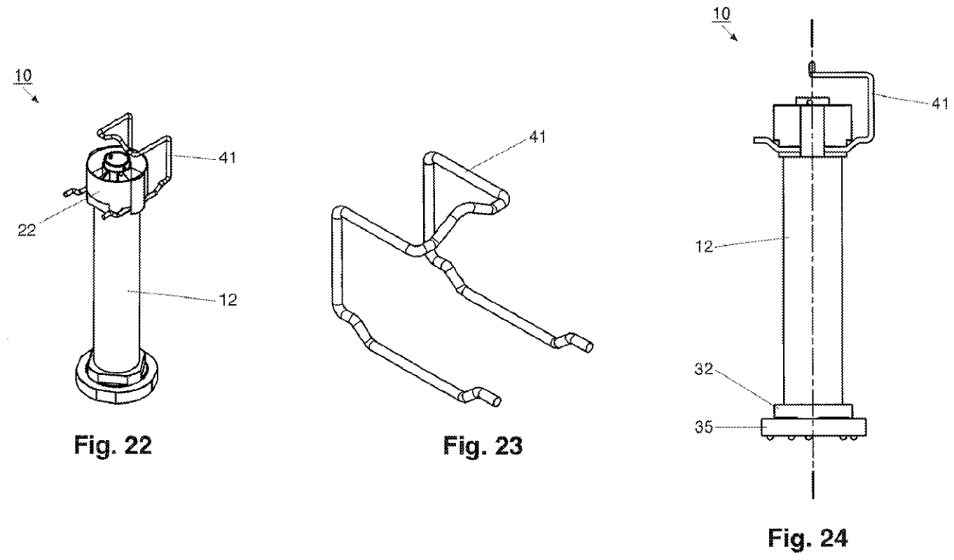

FIGS. 22-24 show and explain another embodiment of the inventive device 10.

FIG. 22 shows the device 10 in an assembled state when a hanging bracket 41 is attached to the end piece 22.

According to the cross-sectional view of FIG. 13, a receptacle 42 is formed on the end piece 22 at its front side facing the outer tube 12.

FIG. 23 shows the hanging bracket 41 in a perspective view.

A synopsis of FIG. 23 and FIG. 13 makes it clear that the hanging bracket 41 with its two free ends is inserted or plugged into the receptacle 42, respectively, until the hanging bracket 41 is assembled, according to the representation in FIG. 22 or FIG. 24.

By means of the hanging bracket 41 it is possible to hang the device 10, when assembled (with or without an inner tube 16), in an oven, for example, in order to prepare or cook a mass to be cooked which has been inserted into the device 10.

At this point, reference is again made to the above-mentioned nubs 40, which are formed on one of the undersides of the end cap 35 (cf. FIG. 17, FIG. 19). If the device 10 is placed in a heated water bath for cooking purposes, the nubs 40 serve to ensure that the underside of the end cap 35 does not come into contact with the bottom of a pot or the like, but instead is ranged at a distance thereto, which corresponds to the height of the nubs 40 with which they protrude from the underside of the end cap 35. Steam bubbles, which usually form in a heated water bath, can escape laterally in the area of the underside of the end cap 35. This improves the stability of the inventive device 10, when the outer tube 12 is inserted into a water bath with the end cap 35 attached to it.

The invention now works as follows:

Starting from when the device 10 is disassembled, the end cap 35 is first screwed to the outer tube 12 using the ring element 32 at the bottom end 13, as explained. The use of the sealing element 38, which is inserted between the bottom edge 13 of the outer tube 12 and the end cap 35, ensures that the outer tube 12 at its bottom end 13 is well sealed from the surrounding area.

Next, the end piece 22 is placed on the top end 14 of the outer tube 12 and form-fittingly connected to the outer tube 12 by means of the bayonet mechanism 30, 31.

The inner tube 16 with its bottom end 17 can then be passed through the centric guide opening 24 of the end piece 22 and thus inserted into the outer tube 12. As explained, in the assembled state of the device 10, the inner tube 16 with its bottom end 17 rests on the ring-shaped elevation 39, which is formed on the sealing element 38. As a result, the inner tube 16 is precisely centered within the outer tube 12, whereby the ring gap 20 between the two tubes 12, 16 also assumes a constant value.

Following the various assembly steps mentioned above, the inventive device 10 is “operational”.

To prepare a food, for example a “long egg”, cookable egg white is first filled into the ring gap 20 through the passage openings 25, which are not directly arranged between the partition walls 26 (see FIG. 11). A suitable fill level of the egg white can be checked by means of a float, which is inserted into the ring gap 20 through the receptacle opening 28.

As already explained elsewhere, the filling of the ring gap 20 with the egg white is realized homogeneously and in particular without undesirable air pockets. This is achieved by means of the passage opening 25, which is located directly between the partition walls 26, thereby fulfilling the function of a ventilation opening, using the air which is present in the ring gap 20 and is pushed upwards out of the ring gap 20 by the egg white filled into it, and which can escape into the environment.

If, as explained, the ring gap 20 is filled with the egg white as intended, the device 10 is suitably heated from the outside. This can be done by placing the device 10 from the top into a heated water bath. Alternatively, it is also possible to hang the device 10 in an oven or convection oven according to the embodiment of FIGS. 22-24.

After the egg mixture in the ring gap 20 has been sufficiently cooked and has thus solidified or hardened, the inner tube 16 can be pulled out of the outer tube 12 upwards. This can be done by means of a rod or the like, which is inserted into the boreholes 19, which are formed at the top end 18 of the inner tube 16 (see FIG. 7).

In preparation for the above-mentioned extraction of the inner tube 16 from the outer tube 12, the device 10 may be temporarily removed from the water bath or the oven. In this case, the hanging bracket 41 can also be used, which, as explained, is inserted into the receptacle 42 of the end piece 22.

If the hanging bracket 41 is made of plastic or at least is provided with a plastic coating on the external circumferential surface of the corresponding rod element, this is advantageous in ensuring that the hanging bracket 41 does not heat up excessively when the device 10 is heated. This way, the hanging bracket 41 can also be gripped by a user without a potholder or oven mitt, if necessary, without any danger of burning one of the user's hands.

Furthermore, in connection with the above-mentioned extraction of the inner tube 16 from the outer tube 12, it is pointed out that an outer surface of the inner tube 16 may be coated with Teflon. In this context, it is understood that this Teflon coating has food grade properties. In any case, this Teflon coating makes it easier to pull out the inner tube 16 through the centric guide opening 24 upwards and thus to remove the inner tube 16 from the outer tube 12.

According to a further development of the invention, it may also be provided that the inner tube 16 is made entirely of Teflon or a comparable plastic with good sliding properties or a low coefficient of friction. In this way, it is ensured that the inner tube 16 can be extracted from the outer tube 12 and through the centric guide opening 24 of the end piece 22 in a simple manner and without jamming.

Thus, after the inner tube 16 has been extracted or removed from the outer tube 12 as explained, a cavity remains in the center of the solidified egg mass. Next, for the production of the long egg, it is provided that an egg yolk mass is poured into this cavity from above, i.e., from the direction of the top end 14 of the outer tube 12 and through the guide opening 24 of the end piece 22. Subsequently, the device 10 is reheated in a targeted manner, for example in a water bath or in an oven or convection oven.

Once the two egg fractions within the outer tube 12 are sufficiently cooked, the cooking process in which the device 10 is heated from the outside, as explained, is finished.

The removal of the cooked cylindrical egg mass from the outer tube 12 is prepared by first unscrewing the end cap 35 from the ring element 32 and then disassembling it from the bottom end 13 of the outer tube 12. Thus, the bottom end 13 of the outer tube 12 is open again.

After the end cap 35 has been unscrewed from the outer tube 12, the recess 37 referred to above, which is formed in the end cap 35, is used for the purpose of pushing a tool or the like through this recess 37 so that the disc-shaped sealing element 38, which is located on the opposite side of the end cap 35 within the cup-shaped recess, is loosened or removed from the end cap 35.

In a further step, in preparation for the removal of the cooked food from the outer tube 12, the end piece 22 is then disassembled from the top end 14 of the outer tube 12. This can be done in a simple manner by loosening the bayonet lock.

Now that the outer tube 12 has become open again at its two ends 13, 14 after unscrewing or removing the end cap 35 and disassembling the end piece 22, the fully cooked food can be pushed out of the outer tube 12. To this end, for example, the inner tube 16 with a plate attached to one end of it, wherein the diameter of the plate is adapted to the inner diameter of the outer tube 12, can be used as an aid. In other words, an inner tube 16 modified in this way, to which the plate is attached at one end of it, for example, by means of a clamping connection or the like, is used as a “push-out piston” with which the cooked food can be pushed out of the outer tube 12.

The above-mentioned pushing of the fully cooked food out of the outer tube 12 can be facilitated by the fact that the inner circumferential surface of the outer tube 12 is provided with a coating with a low coefficient of friction, such as a food grade Teflon coating. Such a coating ensures that the coefficient of friction of the fully cooked food is reduced with the inner circumferential surface of the outer tube 12 and that the described pushing out of the fully cooked food is easier or possible with even less resistance.

Finally, it is pointed out that the inventive device 10 is characterized in that all of the above-mentioned associated components, namely: outer tube 12, inner tube 16, end piece 22, ring element 32, end cap 35, disc-shaped sealing element 38, hanging bracket 41, can either be connected to each other or disassembled from each other free of tools. This is particularly advantageous for purposes of cleaning the device 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for cooking a food, in particular a mass to be cooked, which contains egg and/or egg fractions or is formed from these ingredients, the device comprising:
an elongated outer tube that is closed at a bottom end;
an elongated inner tube having an outer diameter that is smaller than an inner diameter of the outer tube so that the inner tube is insertable lengthwise into the outer tube and a ring gap is formed between the inner tube and the outer tube;
an end piece adapted to be placed on and attached to an open top end of the outer tube;
at least one passage opening formed in a front of the end piece that aligns with the ring gap formed between the inner tube and the outer tube such that the ring gap is adapted to be filled through the passage opening from an outside when the end piece is placed on the top end of the outer tube, the end piece being cup-shaped at the top and thus open and in an inner area of the end piece, vertical partition walls are provided; and
at least two passage openings formed in the front of the end piece, the at least two passage openings being aligned with the ring gap formed between the inner tube and the outer tube, the at least one passage opening being fluidically separated from the other passage openings by the partition walls so that at least one of the at least two passage opening fulfill a function of a ventilation opening when the ring gap is filled with a mass to be cooked through the other passage opening.

2. The device according to claim 1, wherein the inner tube, when the end piece is placed on the top end of the outer tube, is centered by the end piece inside the outer tube.

3. The device according to claim 2, wherein the end piece has a centric guide opening in its front, the inner diameter of which is adapted to the outer diameter of the inner tube, wherein the inner tube has a greater length than the outer tube and the inner tube when inserted into the outer tube and protrudes upwards from the outer tube and is surrounded by the centric guide opening.

4. The device according to claim 3, wherein the inner tube, when held centrically within the outer tube, is adapted to be removed upwards from the outer tube through the centric guide opening of the end piece.

5. The device according to claim 1, wherein at least one receiving opening is formed in the front of the end piece, in which a thermocouple or a float is insertable, thus protruding into the ring gap formed between the inner tube and the outer tube.

6. The device according to claim 1, wherein on the bottom of the end piece, bayonet pins are formed, which are brought into engagement with bayonet recesses formed adjacent to a top edge area of the outer tube in order to connect the end piece and the outer tube with each other.

7. The device according to claim 1, wherein a ring element is attached to a bottom end of the outer tube, the inner diameter of which is adapted to the outer diameter of the outer tube.

8. The device according to claim 7, wherein an edge area at the bottom end of the outer tube is flanged so that the ring element, when placed on the outer tube from the top end, rests on the flanged edge area of the outer tube with a bevel formed on its inner circumferential surface.

9. The device according to claim 7, wherein the open bottom end of the outer tube is closed by an end cap, and wherein the end cap is cup-shaped and has an inner thread on its inner circumferential surface, which is screwed to an outer thread formed on the outer circumferential surface of the ring element.

10. The device according to claim 9, wherein a disc-shaped sealing element is inserted between the end cap and the bottom end of the outer tube when the ring element is placed on it.

11. The device according to claim 10, wherein in a central area of the sealing element, on a side facing the inner tube, a ring-shaped elevation is formed, the diameter of which is adapted to the inner diameter of the inner tube so that the inner tube, when inserted into the outer tube, rests with its bottom end on the elevation and is thus held centrically within the outer tube or wherein the ring-shaped elevation is conical at its outer circumference so that the outer diameter of this ring-shaped elevation decreases from the surface of the sealing element upwards.

12. The device according to claim 9, wherein on the underside of the end cap there is a plurality of nubs protruding from the underside, and wherein the nubs are arranged on the underside of the end cap adjacent to the outer circumference at uniform distances to another.

13. The device according to claim 9, wherein a centric area of the end cap is traversed by a recess.

14. The device according to claim 1, wherein a receptacle is formed on the end piece in which a hanging bracket is attached, with which the device is hung when assembled.
